(19) United States
(12) Patent Application Publication
(10) Pub. No.: US 2016/0363810 A1
(43) Pub. Date: Dec. 15, 2016

(54) Display Panel

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Huijie Xie, Beijing (CN); Jianyun Xie, Beijing (CN); Kaixuan Wang, Beijing (CN)

(21) Appl. No.: 14/771,317

(22) PCT Filed: Nov. 14, 2014
(86) PCT No.: PCT/CN2014/091116

§ 371 Date: Aug. 28, 2015

(30) Foreign Application Priority Data
Jul. 31, 2014 (CN) 201410374632.4

(51) Int. Cl. G02F 1/1335; G02F 1/1343; G02F 1/1368

(52) U.S. Cl. CPC G02F 1/133514; G02F 1/1368; G02F 1/1343; G02F 2201/123; G02F 2001/133357

(57) ABSTRACT

Embodiments include a display panel that comprises a first substrate, second substrate and liquid crystal layer positioned therebetween. A distance between the first and second substrate in a center region of an effective display region of the display panel is a first distance, and a distance between the first substrate and second substrate in an edge region of the effective display region of the display panel is a second distance; the first distance is greater than the second distance, and the first and second distances have a first difference value, so that an optical path difference in the liquid crystal layer of light rays emitted to the central region of the effective display region is greater than an optical path difference in the liquid crystal layer of light rays emitted to the edge region of the effective display region, and the optical path differences have a preset difference value.

### TECHNICAL FIELD

Embodiments of the disclosure relate to a display panel.

### BACKGROUND

As illustrated in FIG. 1, a display panel of a liquid crystal display device comprises an array substrate 1, a color filter substrate 2 and a liquid crystal layer 3 arranged therebetween. Supporting members are generally arranged between the array substrate 1 and the color filter substrate 2, to reserve a preset distance between the array substrate and the color filter substrate, and maintain the preset distance. In an effective display region 4 of the display panel, the support members generally are spacers 5; in a frame 6 (positioned in a non-display region around the effective display region) of the display panel, the supporting members generally are Si balls 7.

In the effective display region 4 of the display panel, a Thin Film Transistor (TFT) is generally prepared on the array substrate 1, to serve as a switch element; the TFT includes a gate electrode, a gate insulating layer, an active layer, source and drain electrodes and other structures. In the frame 6 of the display panel, as it is not used for display, no TFT needs to be prepared, or there is no need to prepare a TFT having a same structure with the TFT in the effective display region 4. In this case, as illustrated in FIG. 1, a thickness of the array substrate 1 in the frame 6 is less than a thickness thereof in the effective display region 4. In this way, it is hard to determine a required height of the Si balls to be placed in the frame 6 in practice, so that the frame of the display panel is non-uniformly supported by the Si balls. For example, a non-uniform support of the Si balls to the frame includes two situations: the Si balls 7 are insufficient in height, and thus cannot support the array substrate 1 and the color filter substrate 2; or, the Si balls 7 are so high that the array substrate 1 and the color filter substrate 2 are jacked up.

When the array substrate 1 and the color filter substrate 2 are jacked up by the Si balls 7 at the frame 6, a distance between the array substrate 1 and the color filter substrate 2 in an edge region of the effective display region 4 is greater than a distance between the array substrate 1 and the color filter substrate 2 in a central region of the effective display region 4, so when the display panel displays an image, the image displayed in the edge region of the effective display region 4 has a color cast, for example, being yellowish.

### SUMMARY

According to an embodiment of the disclosure, a display panel is provided. The display panel comprises a first substrate, a second substrate and a liquid crystal layer positioned therebetween. A distance between the first substrate and the second substrate in a center region of an effective display region of the display panel is a first distance, and a distance between the first substrate and the second substrate in an edge region of the effective display region of the display panel is a second distance; the first distance is greater than the second distance, and the first and second distances have a first difference value, so that an optical path difference in the liquid crystal layer of light rays emitted to the central region of the effective display region is greater than an optical path difference in the liquid crystal layer of light rays emitted to the edge region of the effective display region, and the optical path differences have a preset difference value.

For example, the first substrate includes a first base substrate and a color filter arranged on the first base substrate, the color filter being positioned on a side of the first base substrate facing the second substrate; the color filter includes a color filter layer, a region of the color filter layer corresponding to the edge region of the effective display region protruding towards a direction of the second substrate, and a protruding height thereof being equal to the first difference value.

For example, the first substrate includes a first base substrate and a color filter arranged on the first base substrate, the color filter being positioned on a side of the first base substrate facing the second substrate; the color filter includes a planarization layer, a region of the planarization layer corresponding to the edge region of the effective display region protruding towards a direction of the second substrate, and a protruding height thereof being equal to the first difference value.

For example, the second substrate includes a second base substrate, and a protruding portion arranged on a side of the second base substrate facing the first substrate, the protruding portion being arranged in a region of the second base substrate corresponding to the edge region of the effective display region, and a thickness of the protruding portion being equal to the first difference value.

For example, the first substrate includes a first base substrate and a color filter arranged on the first base substrate, the color filter being positioned on a side of the first base substrate facing the second substrate; the color filter includes a color filter layer and a planarization layer, regions of the color filter layer and the planarization layer corresponding to the edge region of the effective display region both protruding towards a direction of the second substrate, and a sum of the protruding height of the color filter layer and a protruding height of the planarization layer being equal to the first difference value.

For example, the first substrate includes a first base substrate and a color filter arranged on the first base substrate, the color filter being positioned on a side of the first base substrate facing the second substrate; the color filter includes a color filter layer, a region of the color filter layer corresponding to the edge region of the effective display region protruding towards a direction of the second substrate;

The second substrate includes a second base substrate, and a protruding portion arranged on a side of the second base substrate facing the first substrate, the protruding portion being arranged in a region of the second base substrate corresponding to the edge region of the effective display region; and a sum of a protruding height of the color filter layer and a thickness of the protruding portion is equal to the first difference value.

For example, the first substrate includes a first base substrate and a color filter arranged on the first base substrate, the color filter being positioned on a side of the first base substrate facing the second substrate; the color filter includes a planarization layer, a region of the planarization layer corresponding to the edge region of the effective display region protruding towards a direction of the second substrate;

The second substrate includes a second base substrate, and a protruding portion arranged on a side of the second base substrate facing the first substrate, the protruding portion being arranged in a region of the second base substrate corresponding to the edge region of the effective display region; and a sum of a protruding height of the planarization layer and a thickness of the protruding portion is equal to the first difference value.

For example, the first substrate includes a first base substrate and a color filter arranged on the first base substrate, the color filter being positioned on a side of the first base substrate facing the second substrate; the color filter includes a color filter layer and a planarization layer, regions of the color filter layer and the planarization layer corresponding to the edge region of the effective display region protruding towards a direction of the second substrate; the second substrate includes a second base substrate, and a protruding portion arranged on a side of the second base substrate facing the first substrate, the protruding portion is arranged in a region of the second base substrate corresponding to the edge region of the effective display region; and a sum of a protruding height of the color filter layer, a protruding height of the planarization layer and a thickness of the protruding portion is equal to the first difference value.

For example, the second substrate further includes a thin film transistor and a pixel electrode arranged on the second base substrate, and a transparent resin layer, the transparent resin layer covering the thin film transistor and the pixel electrode; and the protruding portion and the transparent resin layer are in a same layer and formed by a same patterning process.

For example, the preset difference value is within a range of 10-50 nm.

For example, the optical path difference in the liquid crystal layer of light rays emitted to the central region of the effective display region is within a range of 300-350 nm.

### BRIEF DESCRIPTION OF THE DRAWINGS

In order to clearly illustrate the technical solution of the embodiments of the disclosure, the drawings of the embodiments will be briefly described hereinafter; it is obvious that the described drawings are only related to some embodiments of the disclosure and thus are not limitative of the disclosure.

FIG. 1 is a schematic diagram of a display panel of an existing display device;

FIG. 2 is a schematic diagram of an effective display region of a display panel provided by a first embodiment of the disclosure;

FIG. 3 is a schematic diagram of an effective display region of a display panel provided by a second embodiment of the disclosure;

FIG. 4 is a schematic diagram of an effective display region of a display panel provided by a third embodiment of the disclosure;

FIG. 5 is a schematic diagram of an effective display region of a display panel provided by a fourth embodiment of the disclosure;

FIG. 6 is a schematic diagram of an effective display region of a display panel provided by a fifth embodiment of the disclosure;

FIG. 7 is a schematic diagram of an effective display region of a display panel provided by a sixth embodiment of the disclosure;

FIG. 8 is a schematic diagram of an effective display region of a display panel provided by a seventh embodiment of the disclosure.

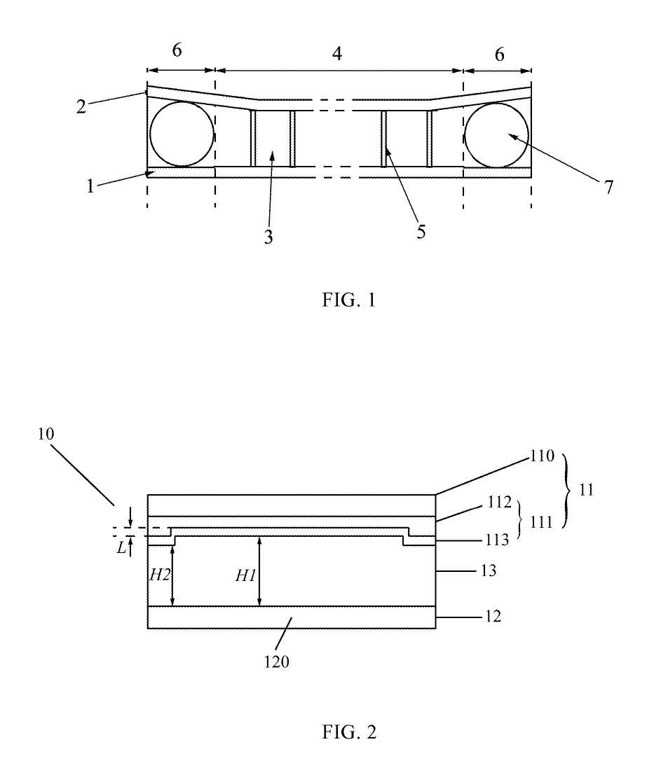

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

FIG. 2 is a schematic diagram of an effective display region of a display panel provided by a first embodiment of the disclosure. As illustrated in FIG. 2, a display panel 10 comprises a first substrate 11, a second substrate 12 and a liquid crystal layer 13 therebetween; wherein a distance between the first substrate 11 and the second substrate 12 in a central region of an effective display region of the display panel 10 is a first distance H1, and a distance between the first substrate 11 and the second substrate 12 in an edge region of the effective display region of the display panel 10 is a second distance H2; the first distance H1 is greater than the second distance H2, and the first distance H1 and the second distance H2 have a first difference value L, so that an optical path difference Δ1 of light rays emitted to the central region of the effective display region when passing through the liquid crystal layer 13 is greater than an optical path difference Δ2 of light rays emitted to the edge region of the effective display region when passing through the liquid crystal layer 13, and the optical path differences Δ1 and Δ2 have a preset difference value Δ. For example, a width of the edge region of the effective display region is 3-10 mm.

A relationship between the first distance H1 and the optical path difference Δ1, and a relationship between the second distance H2 and the optical path difference Δ2 can be expressed by formulas (1) and (2) below:

Δ1=H1×Δn (1)

Δ2=H2×Δn (2)

where, Δn is a birefringence of liquid crystal in the liquid crystal layer 13, namely a difference of two principal refractive indexes of the liquid crystal material.

Δ=(H1−H2)×Δn=L×Δn (3)

Besides the effective display region, the display panel further comprises a frame which is positioned around the effective display region. In the prior art, as the frame of the display panel is non-uniformly supported by Si balls, the distance between the array substrate and the color filter substrate in the edge region (the region in the effective display region close to the frame of the display region) of the effective display region is greater than the distance between the array substrate and the color filter substrate in the central region of the effective display region, so when an image is displayed, the edge region of the effective display region has a color cast.

In the display panel 10 provided by the embodiment, by controlling the first substrate 11 and the second substrate 12 to have a first distance H1 in the central region of the effective display region, and to have a second distance H2 in the edge region of the effective display region, and controlling the difference value between the first distance H1 and the second distance H2 to be a first difference value L, the first difference value L compensates a difference value between the distance of the first substrate 11 and the second substrate 12 in the edge region of the effective display region and the distance thereof in the central region of the effective display region, so that the optical path difference Δ1 in the liquid crystal layer 13 of light rays emitted to the central region of the effective display region is greater than the optical path difference Δ2 in the liquid crystal layer 13 of light rays emitted to the edge region of the effective display region, and the difference value between the optical path differences is a preset difference value Δ; the preset difference value Δ can compensate and improve the color cast problem in the edge region of the effective display region of the display panel 10 caused by that the frame of the display panel 10 is non-uniformly supported by the Si balls, so that each region of the effective display region of the display panel 10 presents standard color orientation, and thereby improving quality of the displayed image.

For example, the first substrate 11 is a color filter substrate including a first base substrate 110 and a color filter 111 arranged on the first base substrate 110, the color filter 111 being positioned on a side of the first base substrate facing the second substrate 12; the color filter 111 includes a color filter layer 112 and a planarization layer 113; the second substrate 12 is an array substrate including a second base substrate 120, a pixel electrode (not illustrated) and a thin film transistor (TFT, not illustrated).

For example, a region of the color filter layer 112 corresponding to the edge region of the effective display region protrudes towards a direction of the second substrate 12, and a protruding height thereof is equal to the first difference value L. Therefore, the first distance H1 can be greater than the second distance H2, and the difference value between the first distance H1 and the second distance H2 is L. In this way, the optical path difference 42 in the liquid crystal layer 13 of light rays emitted to the edge region of the effective display region can be smaller than the optical path difference Δ1 in the liquid crystal layer 13 of light rays emitted to the central region of the effective display region, and the optical path differences Δ1 and Δ2 have a preset difference value Δ; the preset difference value Δ can compensate and improve the color cast in the edge region of the effective display region of the display panel 10, so that each region of the effective display region presents standard color orientation, and thereby improving quality of the displayed image.

For example, the color filter layer 112 is a color film which is made of resin material and includes resin pieces with three colors: R, G and B (namely, red resin pieces, green resin pieces and blue resin pieces). In this case, the region of the color filter layer corresponding to the edge region of the effective display region protruding towards the direction of the second substrate 12 means that a thickness of the red resin pieces, green resin pieces or blue resin pieces positioned in the above region is greater than that of the red resin pieces, green resin pieces or blue resin pieces positioned in other regions of the color filter layer 112, and a protruding direction of the thickness is towards the second substrate 12.

For example, the preset difference value Δ is within a range of 10-50 nm; in a case that the birefringence of the liquid crystal in the liquid crystal layer 13 is 0.1, the first difference value L is 0.1-0.5 μm according to the formula (3). For example, the optical path difference Δ1 in the liquid crystal layer of light rays emitted to the central region of the effective display region of the display panel 10 is within a range of 300-350 nm.

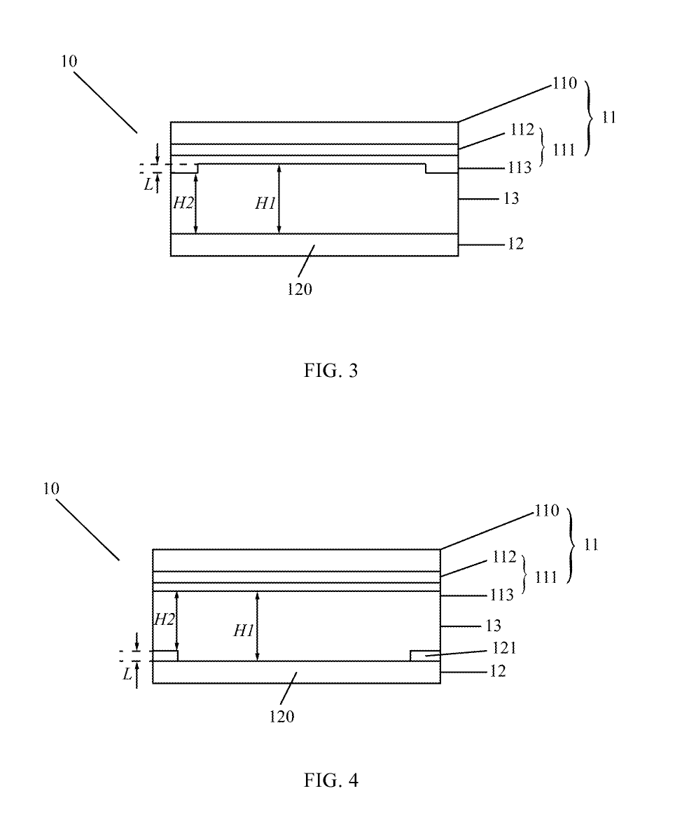

FIG. 3 is a schematic diagram of an effective display region of a display panel provided by a second embodiment of the disclosure. Only differences between a display panel 10 provided by the second embodiment and the display panel 10 in the above first embodiment are described in detail hereinafter, and same contents of the display panel 10 provided by the second embodiment and that of the first embodiment are no more described herein.

As illustrated in FIG. 3, in the second embodiment, a thickness of the region of the color filter layer 112 corresponding to the edge region of the effective display region is identical with thicknesses of other regions of the color filter layer 112; a region of the planarization layer 113 corresponding to the edge region of the effective display region protrudes towards a direction of the second substrate 12, and a protruding height thereof is equal to the first different value L. Therefore, the first distance H1 can be greater than the second distance H2, and the difference value between the first distance H1 and the second distance H2 is L. In this way, the optical path difference Δ2 in the liquid crystal layer 13 of light rays emitted to the edge region of the effective display region of the display panel 10 can be less than the optical path difference Δ1 in the liquid crystal layer 13 of light rays emitted to the central region of the effective display region, and the optical path differences Δ1 and Δ2 have a preset difference value Δ; the preset difference value Δ can compensate and improve the color cast in the edge region of the effective display region of the display panel 10, so that each region of the effective display region of the display panel 10 presents standard color orientation, and thereby improving quality of the displayed image.

FIG. 4 is a schematic diagram of an effective display region of a display panel provided by a third embodiment of the disclosure. Only differences between a display panel 10 provided by the third embodiment and the display panel 10 in the above first embodiment are described in detail hereinafter, and same contents of the display panel 10 provided by the third embodiment and that of the first embodiment are no more described herein.

As illustrated in FIG. 4, in the third embodiment, thicknesses of regions of the color filter layer 112 and the planarization layer 113 corresponding to the edge region of the effective display region are both identical with thicknesses of other regions of the color filter layer 112 and the planarization layer 113; a protruding portion 121 is arranged on a side of the second base substrate 120 facing the first substrate 11, and the protruding portion 121 is arranged in the region of the second base substrate 120 corresponding to the edge region of the effective display region, and a thickness of the protruding portion 121 is equal to the first difference value L. Therefore, the first distance H1 can be greater than the second distance H2, and the difference value between the first distance H1 and the second distance H2 is L. In this way, the optical path difference Δ2 in the liquid crystal layer 13 of light rays emitted to the edge region of the effective display region of the display panel 10 can be greater than the optical path difference Δ1 in the liquid crystal layer 13 of light rays emitted to the central region of the effective display region of the display panel 10, and the optical path differences Δ1 and Δ2 have a preset difference value Δ; the preset difference value Δ can compensate and improve the color cast in the edge region of the effective display region of the display panel 10, so that each region of the effective display region of the display panel 10 presents standard color orientation, and thereby improving quality of the displayed image.

For example, in the third embodiment, the second substrate 12 further includes a transparent resin layer (not illustrated) which covers the TFT and the pixel electrode arranged on the second base substrate 120. For example, the protruding portion 121 and the transparent resin layer are in a same layer and formed by a same patterning process.

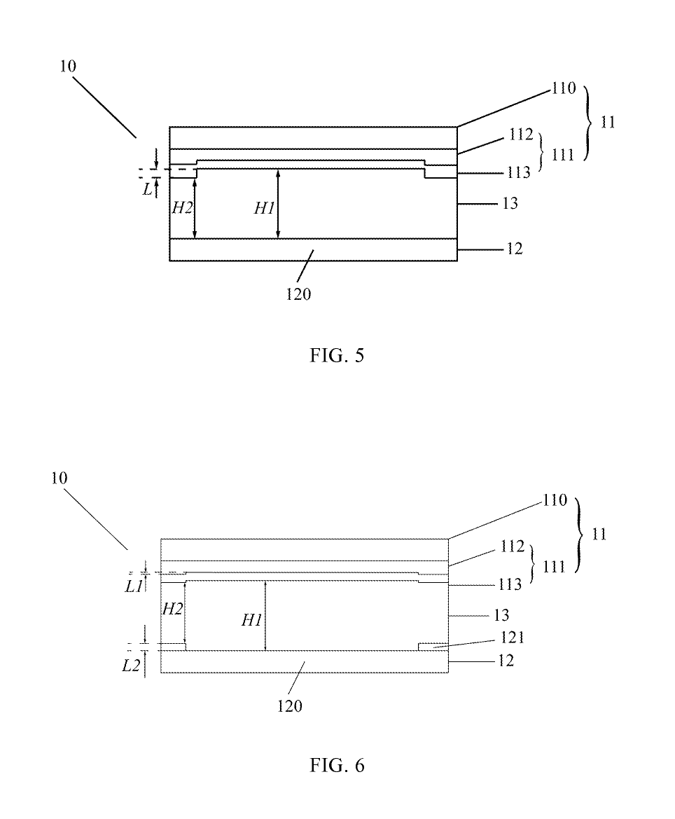

FIG. 5 is a schematic diagram of an effective display region of a display panel provided by a fourth embodiment of the disclosure. Only differences between a display panel 10 provided by the fourth embodiment and the display panel 10 in the above first embodiment are described in details hereinafter, and same contents of the display panel 10 provided by the fourth embodiment and that of the first embodiment are no more described herein.

As illustrated in FIG. 5, in the fourth embodiment, regions of the color filter layer 112 and the planarization layer 113 corresponding to the edge region of the effective display region both protrude towards a direction of the second substrate 12, and a sum of a protruding height of the color filter layer 112 and a protruding height of the planarization layer 113 is equal to the first difference value L. Therefore, the first distance H1 can be greater than the second distance H2, and the difference value between the first distance H1 and the second distance H2 is L. In this way, the optical path difference Δ2 in the liquid crystal layer 13 of light rays emitted to the edge region of the effective display region of the display panel 10 can be less than the optical path difference Δ1 in the liquid crystal layer 13 of light rays emitted to the central region of the effective display region of the display panel 10, and the optical path differences Δ1 and Δ2 have a preset difference value Δ; the preset difference value Δ can compensate and improve the color cast in the edge region of the effective display region of the display panel 10, so that each region of the effective display region of the display panel 10 presents standard color orientation, and thereby improving quality of the displayed image.

FIG. 6 is a schematic diagram of an effective display region of a display panel provided by a fifth embodiment of the disclosure. Only differences between a display panel 10 provided by the fifth embodiment and the display panel 10 in the above first embodiment are described in detail hereinafter, and same contents of the display panel 10 provided by the fifth embodiment and that of the first embodiment are no more described herein.

As illustrated in FIG. 6, in the fifth embodiment, a region of the color filter layer 112 corresponding to the edge region of the effective display region protrudes towards a direction of the second substrate 12; a protruding portion 121 is arranged on a side of the second base substrate 120 facing the first substrate 11, and the protruding portion is arranged in the region of the second base substrate 120 corresponding to the edge region of the effective display region; furthermore, a sum of a protruding height L1 of the color filter layer 112 and a thickness L2 of the protruding portion 121 is equal to the first difference value L. Therefore, the first distance H1 can be greater than the second distance H2, and the difference value between the first distance H1 and the second distance H2 is L. In this way, the optical path difference Δ2 in the liquid crystal layer 13 of light rays emitted to the edge region of the effective display region of the display panel 10 can be less than the optical path difference Δ1 in the liquid crystal layer 13 of light rays emitted to the central region of the effective display region of the display panel 10, and the optical path differences Δ1 and Δ2 have a preset difference value Δ; the preset difference value Δ can compensate and improve the color cast in the edge region of the effective display region of the display panel 10, so that each region of the effective display region of the display panel 10 presents standard color orientation, and thereby improving quality of the displayed image.

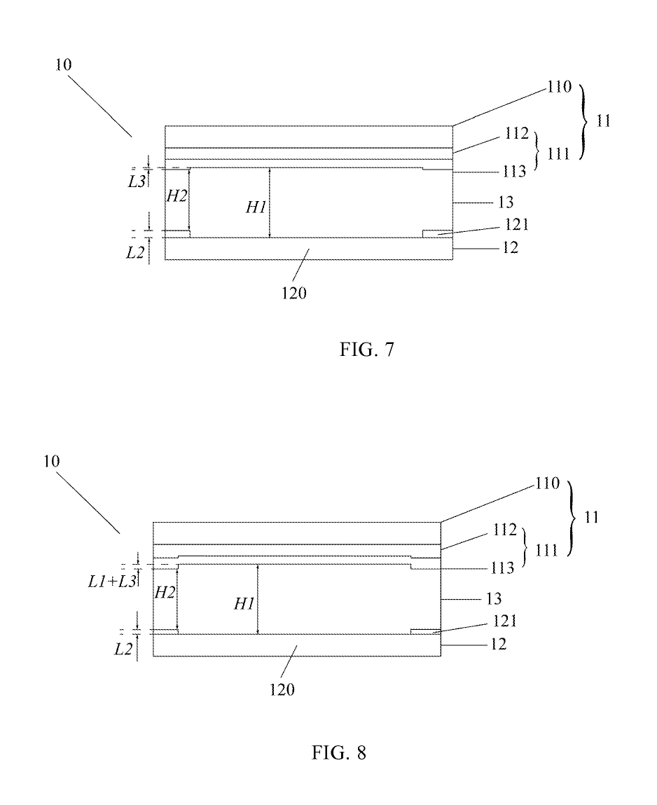

FIG. 7 is a schematic diagram of an effective display region of a display panel provided by a sixth embodiment of the disclosure. Only differences between a display panel 10 provided by the sixth embodiment and the display panel 10 in the above first embodiment are described in detail hereinafter, and same contents of the display panel 10 provided by the sixth embodiment and that of the first embodiment are no more described herein.

As illustrated in FIG. 7, in the sixth embodiment, a region of the planarization layer 113 corresponding to the edge region of the effective display region protrudes towards a direction of the second substrate 12; a protruding portion 121 is arranged on a side of the second base substrate 120 facing the first substrate 11, and the protruding portion 121 arranged in the region of the second base substrate 120 corresponding to the edge region of the effective display region; furthermore, a sum of a protruding height L3 of the planarization layer 113 and a thickness L2 of the protruding portion 121 is equal to the first difference value L. Therefore, the first distance H1 can be greater than the second distance H2, and the difference value between the first distance H1 and the second distance H2 is L. In this way, the optical path difference Δ2 in the liquid crystal layer 13 of light rays emitted to the edge region of the effective display region of the display panel 10 can be less than the optical path difference Δ1 in the liquid crystal layer 13 of light rays emitted to the central region of the effective display region of the display panel 10, and the optical path differences Δ1 and Δ2 have a preset difference value Δ; the preset difference value Δ can compensate and improve the color cast in the edge region of the effective display region of the display panel 10, so that each region of the effective display region of the display panel 10 presents standard color orientation, and thereby improving quality of the displayed image.

FIG. 8 is a schematic diagram of an effective display region of a display panel provided by a seventh embodiment of the disclosure. Only differences between a display panel 10 provided by the seventh embodiment and the display panel 10 in the above first embodiment are described in detail hereinafter, and same contents of the display panel 10 provided by the seventh embodiment and that of the first embodiment are no more described herein.

As illustrated in FIG. 8, in the seventh embodiment, regions of the color filter layer 112 and the planarization layer 113 corresponding to the edge region of the effective display region both protrude towards a direction of the second substrate 12; a protruding portion 121 is arranged on a side of the second base substrate 120 facing the first substrate 11, and the protruding portion 121 is arranged in the region of the second base substrate 120; furthermore corresponding to the edge region of the effective display region, a sum of a protruding height L1 of the color filter layer 112, a protruding height L3 of the planarization layer 113 and a thickness L2 of the protruding portion 121 is equal to the first difference value L. Therefore, the first distance H1 can be greater than the second distance H2, and the difference value between the first distance H1 and the second distance H2 is L. In this way, the optical path difference Δ2 in the liquid crystal layer 13 of light rays emitted to the edge region of the effective display region of the display panel 10 can be less than the optical path difference Δ1 in the liquid crystal layer 13 of light rays emitted to the central region of the effective display region of the display panel 10, and the optical path differences Δ1 and Δ2 have a preset difference value Δ; the preset difference value Δ can compensate and improve the color cast in the edge region of the effective display region of the display panel 10, so that each region of the effective display region of the display panel 10 presents standard color orientation, and thereby improving quality of the displayed image.

The foregoing embodiments merely are exemplary embodiments of the disclosure, and not intended to define the scope of the disclosure, and the scope of the disclosure is determined by the appended claims.

The present application claims priority of Chinese Patent Application No. 201410374632.4 filed on Jul. 31, 2014, the disclosure of which is incorporated herein by reference in its entirety as part of the present application.

1. A display panel, comprising a first substrate, a second substrate and a liquid crystal layer positioned therebetween, wherein,
a distance between the first substrate and the second substrate in a center region of an effective display region of the display panel is a first distance, and a distance between the first substrate and the second substrate in an edge region of the effective display region of the display panel is a second distance; the first distance is greater than the second distance, and the first distance and the second distance have a first difference value, so that an optical path difference in the liquid crystal layer of light rays emitted to the central region of the effective display region is greater than an optical path difference in the liquid crystal layer of light rays emitted to the edge region of the effective display region, and the optical path differences have a preset difference value.

2. The display panel according to claim 1, wherein,
the first substrate includes a first base substrate and a color filter arranged on the first base substrate, the color filter being positioned on a side of the first base substrate facing the second substrate; and
the color filter includes a color filter layer, a region of the color filter layer corresponding to the edge region of the effective display region protruding towards a direction of the second substrate, and a protruding height thereof being equal to the first difference value.

3. The display panel according to claim 1, wherein,
the first substrate includes a first base substrate and a color filter arranged on the first base substrate, the color filter being positioned on a side of the first base substrate facing the second substrate; and
the color filter includes a planarization layer, a region of the planarization layer corresponding to the edge region of the effective display region protruding towards a direction of the second substrate, and a protruding height thereof being equal to the first difference value.

4. The display panel according to claim 1, wherein,
the second substrate includes a second base substrate, and a protruding portion arranged on a side of the second base substrate facing the first substrate, the protruding portion being arranged in a region of the second base substrate corresponding to the edge region of the effective display region, and a thickness of the protruding portion being equal to the first difference value.

5. The display panel according to claim 1, wherein,
the first substrate includes a first base substrate and a color filter arranged on the first base substrate, the color filter being positioned on a side of the first base substrate facing the second substrate; and
the color filter includes a color filter layer and a planarization layer, regions of the color filter layer and the planarization layer corresponding to the edge region of the effective display region both protruding towards a direction of the second substrate, and a sum of a protruding height of the color filter layer and a protruding height of the planarization layer being equal to the first difference value.

6. The display panel according to claim 1, wherein,
the first substrate includes a first base substrate and a color filter arranged on the first base substrate, the color filter being positioned on a side of the first base substrate facing the second substrate;
the color filter includes a color filter layer, a region of the color filter layer corresponding to the edge region of the effective display region protruding towards a direction of the second substrate;
the second substrate includes a second base substrate, and a protruding portion arranged on a side of the second base substrate facing the first substrate, the protruding portion being arranged in a region of the second base substrate corresponding to the edge region of the effective display region; and
a sum of a protruding height of the color filter layer and a thickness of the protruding portion is equal to the first difference value.

7. The display panel according to claim 1, wherein,
the first substrate includes a first base substrate and a color filter arranged on the first base substrate, the color filter being positioned on a side of the first base substrate facing the second substrate;
the color filter includes a planarization layer, a region of the planarization layer corresponding to the edge region of the effective display region protruding towards a direction of the second substrate;
the second substrate includes a second base substrate, and a protruding portion arranged on a side of the second base substrate facing the first substrate, the protruding portion being arranged in a region of the second base substrate corresponding to the edge region of the effective display region; and
a sum of a protruding height of the planarization layer and a thickness of the protruding portion is equal to the first difference value.

8. The display panel according to claim 1, wherein,
the first substrate includes a first base substrate and a color filter arranged on the first base substrate, the color filter being positioned on a side of the first base substrate facing the second substrate;
the color filter includes a color filter layer and a planarization layer, regions of the color filter layer and the planarization layer corresponding to the edge region of the effective display region both protruding towards a direction of the second substrate;
the second substrate includes a second base substrate, and a protruding portion arranged on a side of the second base substrate facing the first substrate, the protruding portion being arranged in a region of the second base substrate corresponding to the edge region of the effective display region; and
a sum of a protruding height of the color filter layer, a protruding height of the planarization layer and a thickness of the protruding portion is equal to the first difference value.

9. The display panel according to claim 4, wherein,
the second substrate further includes a thin film transistor and a pixel electrode arranged on the second base substrate, and a transparent resin layer, the transparent resin layer covering the thin film transistor and the pixel electrode; and
the protruding portion and the transparent resin layer are in a same layer and formed by a same patterning process.

10. The display panel according to claim 1, wherein the preset difference value is within a range of 10-50 nm.

11. The display panel according to claim 1, wherein the optical path difference in the liquid crystal layer of light rays emitted to the central region of the effective display region of the display panel is within a range of 300-350 nm.

12. The display panel according to claim 1, wherein the first substrate includes a first base substrate and a first film layer formed thereon, and the second substrate includes a second base substrate and a second film layer formed thereon,
at least one of the first film layer and the second film layer has a protrusion in the edge region in the effective display region which is protruded towards the liquid crystal layer with respect to the corresponding film layer in the central region of the effective display region, and a total protruding height of the protrusion on the at least one of the first film layer and the second film layer is equal to the first difference value.

13. The display panel according to claim 1, further comprising a frame region which is surrounding the effective region.

14. The display panel according to claim 6, wherein,
the second substrate further includes a thin film transistor and a pixel electrode arranged on the second base substrate, and a transparent resin layer, the transparent resin layer covering the thin film transistor and the pixel electrode; and
the protruding portion and the transparent resin layer are in a same layer and formed by a same patterning process.

15. The display panel according to claim 7, wherein,
the second substrate further includes a thin film transistor and a pixel electrode arranged on the second base substrate, and a transparent resin layer, the transparent resin layer covering the thin film transistor and the pixel electrode; and
the protruding portion and the transparent resin layer are in a same layer and formed by a same patterning process.

16. The display panel according to claim 8, wherein,
the second substrate further includes a thin film transistor and a pixel electrode arranged on the second base substrate, and a transparent resin layer, the transparent resin layer covering the thin film transistor and the pixel electrode; and
the protruding portion and the transparent resin layer are in a same layer and formed by a same patterning process.

17. The display panel according to claim 2, wherein the preset difference value is within a range of 10-50 nm.

18. The display panel according to claim 2, wherein the optical path difference in the liquid crystal layer of light rays emitted to the central region of the effective display region of the display panel is within a range of 300-350 nm.
